(19) United States
(12) Patent Application Publication
(10) Pub. No.: US 2014/0291065 A1
(43) Pub. Date: Oct. 2, 2014

(54) LOUDSPEAKER HAVING EXTERNAL EXTENSION

(71) Applicant: Seon Joon KIM, Ulsan (KR)

(72) Inventor: Seon Joon KIM, Ulsan (KR)

(21) Appl. No.: 14/090,423

(22) Filed: Nov. 26, 2013

(30) Foreign Application Priority Data
Mar. 29, 2013 (KR) 10-2013-0034177

(51) Int. Cl. H04R 1/02

(52) U.S. Cl. CPC H04R 1/02
USPC 181/199

(57) ABSTRACT

A loudspeaker having an external extension includes an enclosure, at least one speaker, and a port formed in a surface of the enclosure so as to communicate with an outside, and a hollow external extension extending from the port outwardly.

### BACKGROUND OF THE INVENTION

1. Technical Field

The present invention relates to a loudspeaker having an external extension, and more particularly, to a loudspeaker having an external extension, which includes an enclosure and at least one speaker unit, and which further has a hollow external extension extending outwardly from a port.

2. Description of the Related Art

Generally, a loudspeaker means a configuration having a speaker unit for directly emitting sounds and an enclosure for enclosing the speaker unit. Here, in the case of using only the speaker unit, a loudspeaker is referred to as a direct loudspeaker, in which sounds at low frequencies are hardly reproduced because of interference and cancellation of sound waves. Accordingly, when the enclosure is used, the enclosure traps sound waves emitted from rear of the loudspeaker so as to prevent the interference and cancellation of sound waves, and also uses a resonance phenomenon actively, thereby effectively reproducing low frequencies.

On the other hand, as shown in FIG. 1, the conventional loudspeaker may be generally classified into a sealed box type loudspeaker, a bass-reflex type loudspeaker, and a back-horn loading type loudspeaker according to the type of the enclosure thereof.

The bass-reflex type loudspeaker has an enclosure in which a front surface or a rear surface is designed to have a port, which enhances low frequencies by using Helmholtz resonance in that sound waves are resonant in a hollow cabinet and the port. At this time, direct facts that determine the performance of the loudspeaker are a volume of the enclosure, an output of a speaker unit, a size and a length of a port and the like. The port can be easily designed, and has a simple manufacturing process compared with a back-horn loading type enclosure. Further, the port has advantages of damping high frequencies and enhancing low frequencies. However, the bass-reflex type enclosure has a large disadvantage in that the design of the port may be changed according to a limitation of a volume of the enclosure.

Further, the bass-reflex type enclosure has another disadvantage in that the port must be disposed in the front surface or the rear surface in order to enhance sound waves emitted from the front of the speaker unit. At this time, a surface of the enclosure including the speaker unit is defined as the front surface.

On the other hand, the back-horn loading type loudspeaker has an enclosure in which sound waves at intermediate and high frequencies are damped by a folded structure while only low frequencies enhanced during passing through a horn are emitted through an exit. In the back-horn loading type loudspeaker, the enclosure has significant disadvantages in that a detailed design is required and a manufacturing process is complicated. Accordingly, the back-horn loading type loudspeaker has a problem in that the penetration rate thereof is low.

### SUMMARY OF THE INVENTION

Accordingly, the present invention has been made to solve the above-mentioned problems in the conventional arts, and an aspect of the present invention is to provide a loudspeaker having an external extension, in which the external extension is freely designed to have a shape, a size and a length regardless of volume and size of the enclosure, so as to effectively damp intermediate and high frequencies and effectively enhance low frequencies and to easily define wavelengths and frequencies of sound waves, and which can secure an advantage of a back-horn loading type loudspeaker in such a way that the external extension is made merely by a casting or assembling, because a port may be designed without relation to an enclosure of the loudspeaker and formed at any position on the enclosure.

In accordance with an aspect of the present invention, a loudspeaker having an external extension is provided. The loudspeaker having the external extension, which includes an enclosure and at least one speaker unit, including: a port formed in a surface of the enclosure so as to communicate with an outside; and a hollow external extension which extends from the port outwardly, wherein low frequencies to be emphasized are determined by a length of the hollow external extension.

Further, the external extension may have at least one bent portion.

Furthermore, the hollow external extension may have a sectional area which is gradually increased from the port.

Moreover, the hollow external extension may have a sectional area which is continuously changed.

In addition, the loudspeaker further includes a hollow duct extending from the port of the enclosure inwardly.

And, the surface of the enclosure in which the port is formed may be different from a surface in which the speaker unit is disposed.

As described above, in the loudspeaker having the external extension according to the present invention, the port is formed at a surface of the enclosure so as to communicate with an outside, and a hollow external extension extends from the port to the outside. The size, the length and the shape of the external extension can be freely designed regardless of the volume and the size of the enclosure, thereby defining the wavelengths and the frequencies of the sound waves. Further, the intermediate and high frequencies can be damped while the low frequencies are effectively enhanced.

Further, the advantage of the back-horn loading type loudspeaker can be implemented through a more easy design and process by using the external extension. That is, since it is unnecessary to implement the shape of a horn only in the enclosure of the loudspeaker, the external extension in the form of the horn can be implemented by a casting or an assembling thereof to have a beautiful curved line, thereby achieving the manufacturing of a high quality and inexpensive loudspeaker and implementing a more complicated structure than to that of the back-horn loading type loudspeaker.

Accordingly, the loudspeaker with high quality can be popularized.

Furthermore, there is an advantage in that a port can be freely formed in a front surface or a rear surface of the enclosure of the loudspeaker without a limitation, differently from a bass-reflex type loudspeaker in which a port or a duct is formed in a front surface of an enclosure, in order to have an effect on the sound waves emitted from the front surface of the enclosure.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a sectional view illustrating the conventional loudspeakers;

FIG. 2 is a sectional view illustrating a loudspeaker having an external extension according to an embodiment of the present invention;

FIGS. 3A to 3E are sectional views illustrating the loudspeaker having an external extension according to various embodiments of the present invention;

FIG. 4 is a sectional view illustrating a loudspeaker having an external extension according to the present invention, in which a horn type extension is implemented; and

FIGS. 5A to 5C are a sectional view illustrating a bass-reflex type loudspeaker having a duct.

### DETAILED DESCRIPTION OF THE EXEMPLARY EMBODIMENTS

The present invention will be described in detail with reference to the accompanying drawings below.

Generally, a loudspeaker S includes an enclosure and at least one speaker unit 20.

Here, in the case of using only the speaker unit 20, a loudspeaker is referred to as a direct loudspeaker in which a sound at a low frequency is hardly reproduced because of interference and a cancellation of sound waves. Accordingly, when the enclosure 10 is used, the enclosure 10 traps sound waves emitted from a rear surface of the speaker unit so as to prevent the interference and cancellation of sound waves, and also uses a resonance phenomenon actively so as to effectively reproduce low frequencies.

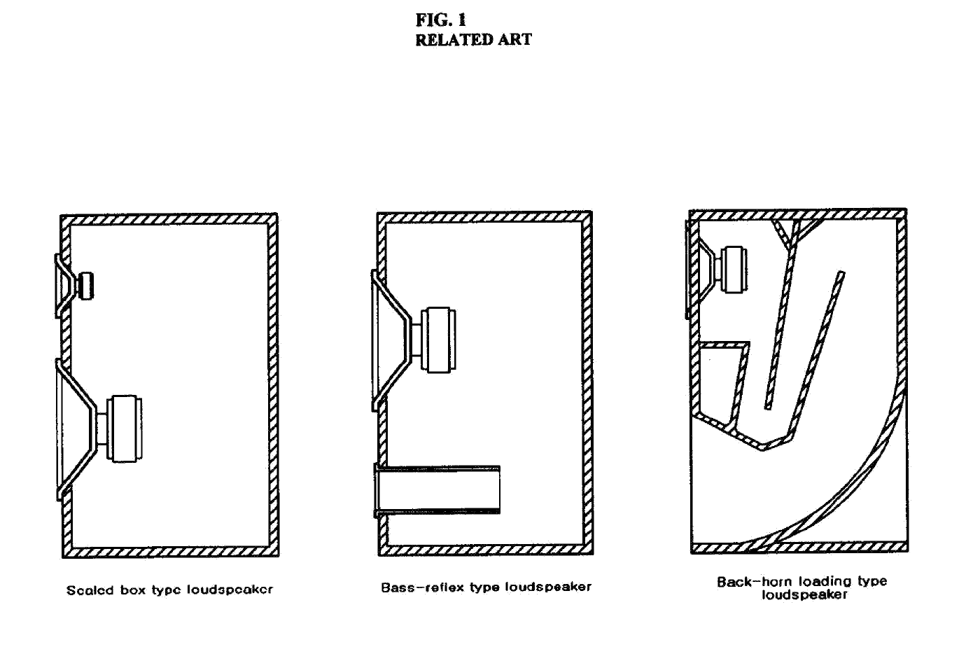

On the other hand, as shown in FIG. 1, the conventional loudspeaker may be generally classified into a sealed box type loudspeaker, a bass-reflex type loudspeaker, and a back-horn loading type loudspeaker according to the type of the enclosure thereof.

The sealed box type loudspeaker has a completely sealed enclosure 10 capable of isolating an effect of sound waves emitted from a rear surface of a speaker unit 20. In this type of loudspeaker, the performance of the loudspeaker is determined by the volume of the enclosure 10 and an output of the speaker unit 20. The sealed box type loudspeaker has a disadvantage of ineffectively using and spending the sound waves.

The bass-reflex type loudspeaker has an enclosure 10 which is designed to have a port 30 or a duct 31 formed in a front surface or a rear surface thereof, and enhances low frequencies by using the Helmholtz resonance which is a phenomenon in which sound waves are resonant in a cavity and the port. At this time, direct facts that determine the performance of the loudspeaker are a volume of the enclosure 10, an output of a speaker unit 20, and a size or a length of the port 30 or the duct 31. In the bass-reflex type loudspeaker, the duct 31 can be respectively and simply designed and easily manufactured in comparison with a horn of the back-horn loading type loudspeaker. Further, the bass-reflex type loudspeaker has an excellent effect in a cancellation of high frequencies and an enhancement of low frequencies compared with a difficulty of a process, and is a mostly popularized loudspeaker. However, the bass-reflect type loudspeaker has a disadvantage in that it is difficult to design the ducts 31 with various shapes and lengths because of a limited volume of the enclosure 10.

Further, the bass-reflex type loudspeaker has another disadvantage in that the duct 31 must be disposed in the front surface or the rear surface of the enclosure in order to enhance sound waves emitted from the front of the speaker unit. Here, a surface of the enclosure 10 including the speaker unit 20 is defined as the front surface.

On the other hand, the back-horn loading type loudspeaker has an enclosure in which sound waves at intermediate and high frequencies are damped by a folded structure thereof while only low frequencies enhanced during passing through a horn are emitted through an exit. In the back-horn loading type loudspeaker, the enclosure has significant disadvantages in that a detailed design is required and a manufacturing process is complicated because of a limited enclosure. Accordingly, the back-horn loading type loudspeaker is expensive and has a problem in that the penetration rate thereof is low and the popularization thereof is failed.

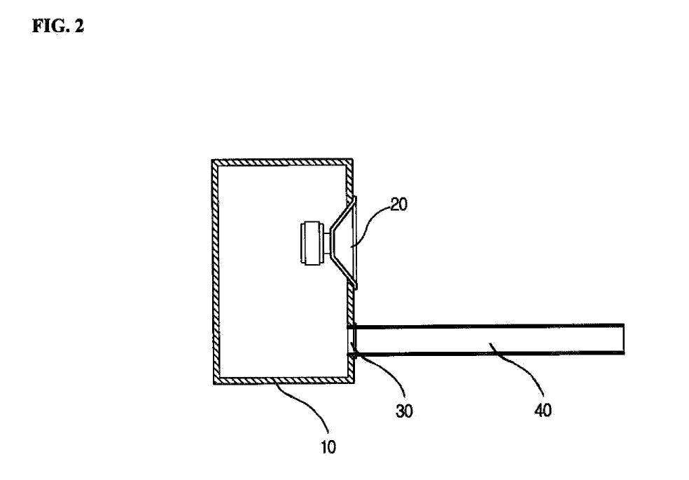

On the other hand, the present invention relates to a loudspeaker having an external extension as shown in FIGS. 2 to 4.

Particularly, according to the present invention, the loudspeaker S includes an enclosure 10 and at least one speaker unit 20. The loudspeaker further includes a hollow typed external extension 40 extending from a port 30 which is formed in a surface of the enclosure and communicates with an outside.

The conventional bass-reflex type speaker has the enclosure 10 in which the port 30 or the duct 31 is formed to have an adjusted length and radius. However, there is a difficulty in designing the port or the duct because of the limited volume of the enclosure.

Therefore, the present invention provides the hollow typed external extension 40 in such a way that the external extension 40 extends from the port 30 to the outside, thereby effectively damping the intermediate and high frequencies while enhancing the low frequencies.

The reason is that in the case that sound waves are refracted in the port due to a basic property of the sound waves, an overtone is effectively damped as its frequency is higher, while an overtone is hardly lost when its frequency is lower.

On the other hand, since the external extension 40 extends from the port 30 to the outside and is not limited by the enclosure 10, various modified embodiments of the external extension 40 can be established. A number of the refractions of the sound waves is made to be increased, thereby improving an effect of damping the intermediate and high frequencies and enhancing the low frequencies.

In other words, by freely designing the size, length and shape of the external extension, the wavelength and the frequency of the sound waves may be defined. Accordingly, it is possible to damp the intermediate and high frequencies and to effectively enhance the low frequencies. Particularly, when a length of a duct is shorter, a high frequency sound is enhanced, while when the length of the duct is longer, a low frequency sound is enhanced. In the case of a bent duct, only an overtone with a high frequency is damped.

This may be expressed by Equation 1 below.

Equation on a wavelength of a sound wave

$$λ = \frac{4 l}{n} \qquad Equation 1$$

in which λ is a wavelength, l is a length of a duct, and n is an odd number equal to and larger than 1 in the case of a closed duct while n is an even number equal to and larger than 2 in the case of an open duct.

Equation on a frequency of a sound wave

$$f = \frac{nv}{4 l} \qquad Equation 2$$

in which f is a frequency, l is a length of a duct, v is a transferring rate of a sound wave (m/s) and n is an odd number equal to and larger than 1 in the case of a closed duct while n is an even number equal to and larger than 2 in the case of an open duct.

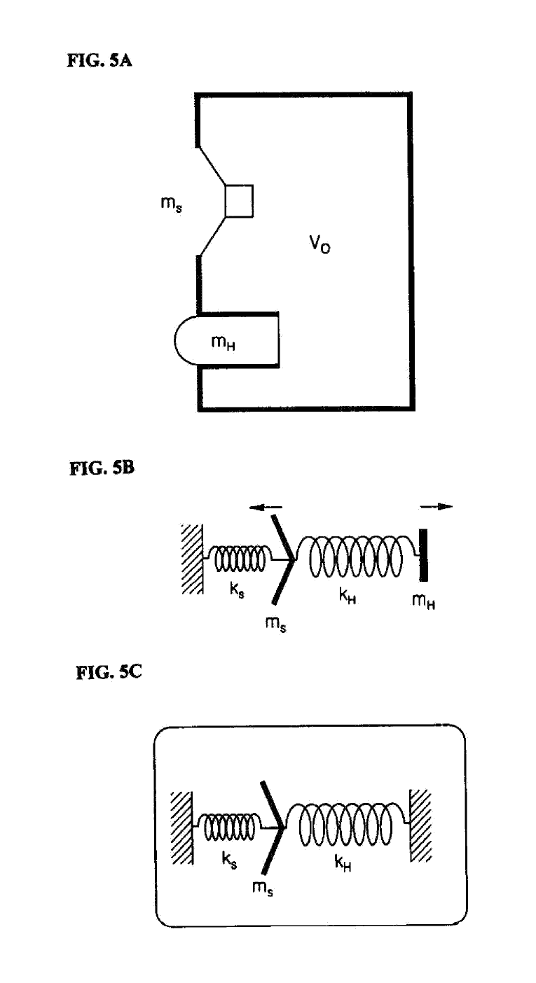

FIGS. 5A to 5C are a sectional view illustrating a bass-reflex type loudspeaker having a duct. Referring to FIGS. 5A to 5C, Vo is a volume of an enclosure, ms is a volume of a vibration plate, and mH is a volume of air in a duct.

A frequency fH of the Helmholtz resonance is as follows.

f_{H}=(v/2π)S/[Vₒ(l+r)]^{1/2} Equation 3

in which v is a velocity of a sound wave in air, s is a sectional area, r is specific heat, Vo is a volume of an enclosure, and l is a length of a duct.

If a frequency is significantly lower than the frequency of the Helmholtz resonance, the vibration plate and the air in the duct vibrate in the same phase, and a sound pressure emitted to the outside is out of phase and ignored. That is, the sound pressure lower than the frequency of the Helmholtz resonance is rapidly damped.

To the contrary, if the frequency of the sound is identical to the resonant frequency, the air in the enclosure and the duct vibrate in the identical phase and the sound pressure emitted to the outside is in the identical phase, while the sound pressure emitted from the duct to the outside is in the identical phase to the sound pressure, resulting in the enhancement of bass.

With the conventional art, the adjustment of the length of the duct means that l in the Equation 1 is adjusted, i.e. the frequency of the Helmholtz resonance is adjusted.

However, in the present invention, the adjustment of the length of the external extension means that the resonant frequency of the external extension is adjusted. Here, the resonant frequency of the external extension is different from the frequency of the Helmholtz resonance.

Referring to the Equation 2 in the description of the present invention, it is noted that a frequency of a standing wave is adjusted by adjusting the length of the hollow typed external extension, thereby determining a low frequency to be emphasized.

Therefore, it will be understood that the external extension of the present invention is not an extension of the duct provided to the conventional bass-reflex loudspeaker but a separate unit operating according to a physical principle which is completely different from that applied to the conventional bass-reflex loudspeaker.

On the other hand, a conventional loudspeaker system using an effect of damping intermediate and high frequencies in the bent duct refers to the back-horn loading type loudspeaker. However, in the case of the back-horn loading type loudspeaker as described above, since a shape of a horn must be implemented in space defined in the loudspeaker, a design of the enclosure is complicated and a process of manufacturing the enclosure is complex. Further, the back-horn loading typed loudspeaker has problems in that a manufacturing cost increases and a mass-manufacturing is impossible.

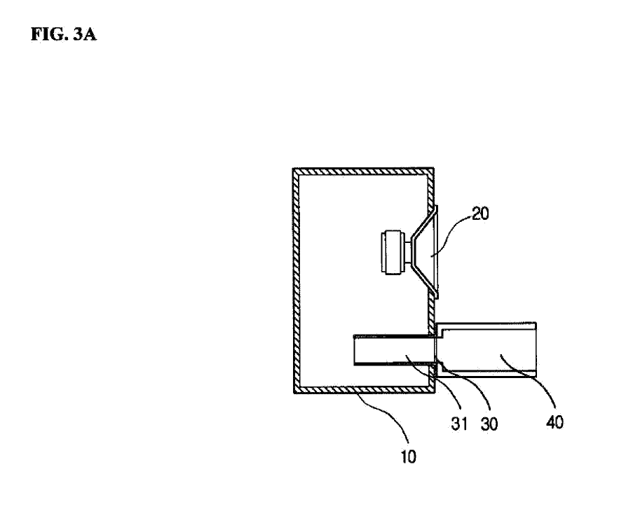

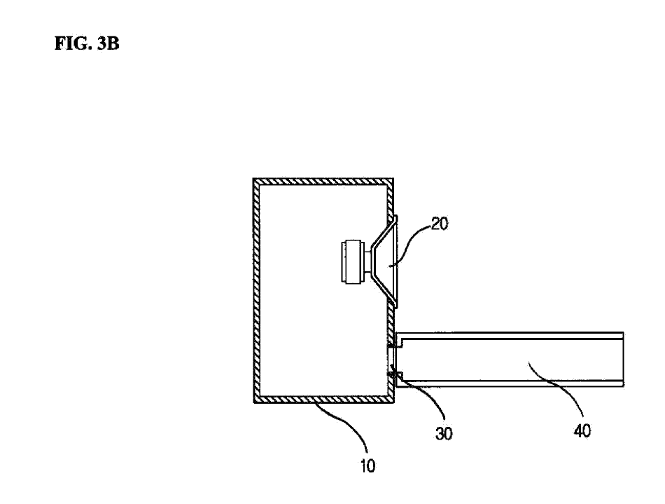

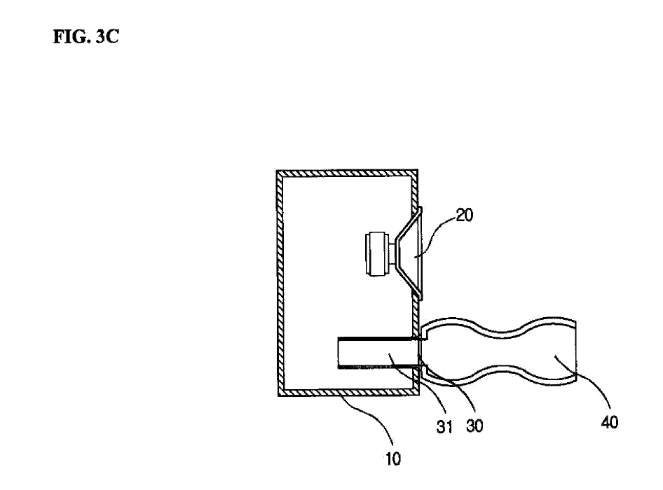

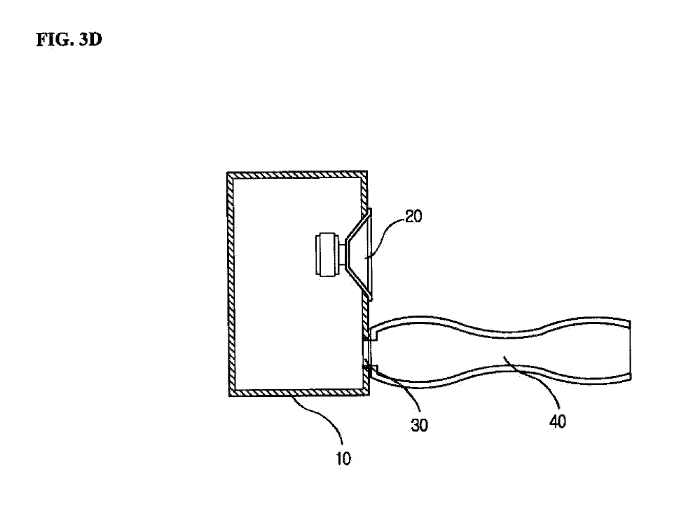

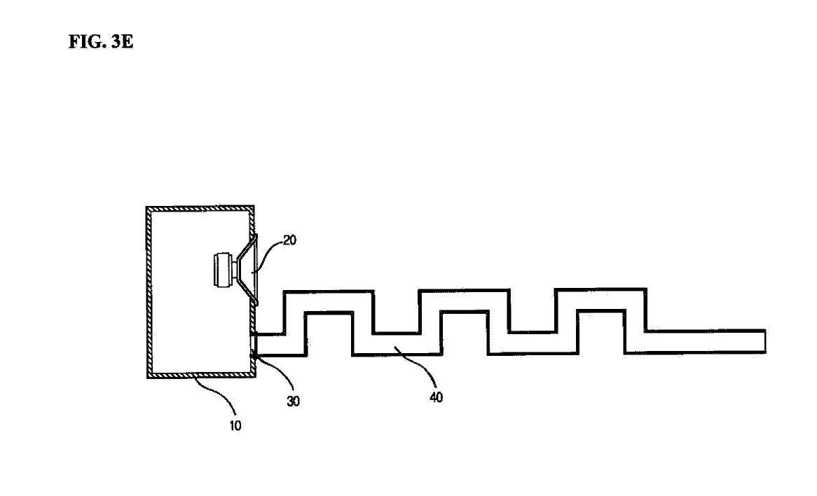

According to an embodiment of the present invention, the external extension 40 may have a shape in which it is bent at least one time, as shown in FIG. 3E.

In such a back-horn loading typed speaker, the sound waves at the intermediated and high frequencies are damped by the shape of the bent duct, and only low frequencies enhanced during passing through the horn are emitted through an exit.

By using the principle, the external extension 40 is bent, thereby damping the intermediate and high frequencies.

Particularly, in the sound waves passing through a sound path, intermediate and high frequencies of the sound waves are isolated by an action of an acoustic filter and only low frequencies pass through the bent portion of the external extension 40.

As another embodiment, the external extension 40 may have a hollow section gradually increasing from the port 30. This may also have a shape corresponding to a design of the horn in the back-horn loading typed speaker.

Particularly, the horn refers to a structure in that a sectional area of the sound path is gradually increased by an exponential function as the sound waves progress. At this time, an efficiency is improved by an effect of impedance matching in the sound waves of the speaker unit 20 and the external extension 40, and the phase of the sound waves is also transformed by an effect of an adjustable time delay, so that the sound waves join direct waves emitted from the front surface of the speaker unit and the intermediate and low frequencies which generally are hardly reproduced can be powerfully reproduced.

Accordingly, with the design of the shape of the external extension 40, it is possible to freely design the external extension which is not restricted by space, thereby implementing the shape of the internal horn of the back-horn loading type the loudspeaker in the external extension 40.

That is, since it is unnecessary to implement the shape of a horn only in the enclosure of the loudspeaker, the external extension in the form of the horn may be implemented by a casting or an assembling thereof to have a beautiful curved line, thereby achieving the manufacturing of a high quality and inexpensive loudspeaker and implementing a more complicated structure than that of the back-horn loading type loudspeaker.

Accordingly, a loudspeaker with a high quality may be popularized at an inexpensive price.

Further, the external extension 40 may have a hollow sectional area which is gradually changed.

Furthermore, the sound waves which have wave lengths corresponding to the sectional shape can be effectively enhanced and reproduced.

On the other hand, the conventional bass-reflex type loudspeakers are constructed not to the outside of the enclosure like the present invention, but in the enclosure. Therefore, the design has been restricted by the size of the enclosure.

In comparison with the conventional bass-reflex type loudspeakers, since the present invention is constructed to the outside of the enclosure, the size, length and shape of the external extension may be freely designed regardless of the volume and size of the enclosure, thereby freely defining the wavelengths and frequencies of the sound waves and damping the intermediate and high frequencies while effectively enhancing the low frequencies.

The present invention further includes a hollow duct 31 extending from the port 30 of the enclosure 10 inwardly.

That is, the conventional bass-reflex type loudspeaker has the enclosure 10 in which the port 30 or the duct 31 is formed in the front surface or the rear surface of the enclosure 10 so as to use the Helmholtz resonance which is a phenomenon in that the sound waves are resonant in a cavity and the port. The present invention may have a structure in that an effect of the Helmholtz resonance is provided through a configuration of the duct 31 while simultaneously an effect of the enhancement of the low frequencies is additionally provided through the external extension 40.

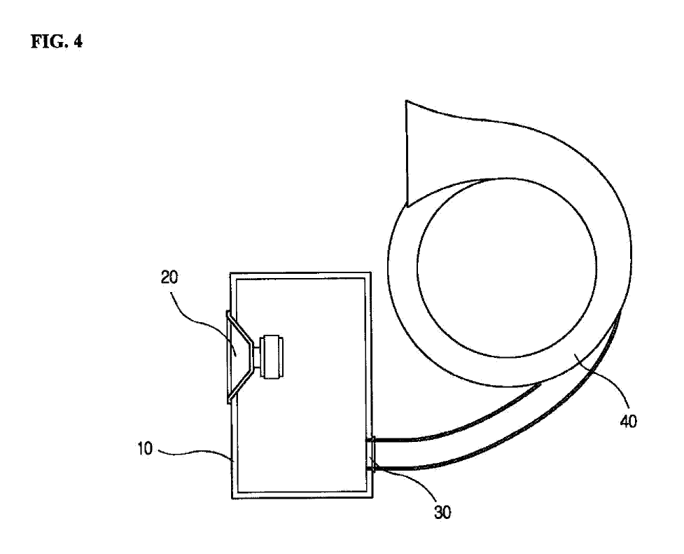

According to the present invention, on the other hand, a surface of the enclosure 10 in which the port 30 is formed may be different from that in which the speaker unit 20 is disposed, as shown in FIG. 4.

In the bass-reflex loading typed loudspeaker which simply emits the low frequencies out of the loudspeaker, there are many cases in that the port 30 or the duct 31 is formed in the front surface of the enclosure in order to easily have an effect on the sound waves emitted forwardly from the speaker unit 20.

However, the loudspeaker having the external extension according to the present invention has an advantage in that the port 30 for the external extension is formed in the front surface or the rear surface of the enclosure without a limit, differently from the bass-reflex type loudspeaker.

That is, when a design of the external extension 40 is freely changed regardless of the surface of the enclosure in which the port 30 is formed, so that an outer end of the external extension 40 is directed from the front surface to the outside, the low frequencies can be effectively emitted.

Furthermore, if the shape of the internal horn of the back-horn loading typed loudspeaker is implemented to the external extension 40, the port 30 is preferably formed in the rear surface.

While the present invention has been described with reference to the embodiments, it will be understood by a person skilled in the art that the present invention may be changed and modified without departing from the scope of the present invention.

What is claimed is:

1. A loudspeaker having an external extension, which includes an enclosure and at least one speaker unit, the loudspeaker comprising:
a port formed in a surface of the enclosure so as to communicate with an outside; and
a hollow external extension which extends from the port outwardly,
wherein low frequencies to be emphasized are determined by a length of the hollow external extension.

2. The loudspeaker as claimed in claim 1, wherein the external extension has at least one bent portion, and intermediate and high frequencies to be damped are determined depending on a number of times of bending.

3. The loudspeaker as claimed in claim 1, wherein the hollow external extension has a sectional area which is gradually increased from the port.

4. The loudspeaker as claimed in claim 2, wherein the hollow external extension has a sectional area which is gradually increased from the port.

5. The loudspeaker as claimed in claim 1, wherein the hollow external extension has a sectional area which is continuously changed.

6. The loudspeaker as claimed in claim 1, further comprising a hollow duct extending from the port of the enclosure inwardly.

7. The loudspeaker as claimed in claim 1, wherein the surface of the enclosure in which the port is formed is different from a surface in which the speaker unit is disposed.
